(19) United States
(12) Patent Application Publication
(10) Pub. No.: US 2006/0120625 A1
(43) Pub. Date: Jun. 8, 2006

(54) System and method for rectified mosaicing of images recorded by a moving camera

(75) Inventors: Shmuel Peleg, Mevaseret-Zion (IL); Assaf Zomet, Karkur (IL); Chetan Arora, New Delhi (IN); Takeo Miyazawa, Tokyo (JP)

Correspondence Address: WOLF, BLOCK, SCHORR & SOLIS-COHEN LLP, 250 PARK AVENUE, NEW YORK, NY, 10177, US

(73) Assignees: Yissum Research Development Company of the Hebrew University, Jerusalem (IL); Emaki, Inc,, Fukishima Prefecture (JP)

(21) Appl. No.: 11/271,465

(22) Filed: Nov. 10, 2005

Related U.S. Application Data
(63) Continuation of application No. 09/642,572, filed on Aug. 20, 2000.
(60) Provisional application No. 60/149,969, filed on Aug. 20, 1999.
(60) Provisional application No. 60/168,421, filed on Nov. 29, 1999.

(51) Int. Cl. G06K 9/36; G06K 9/32

(52) U.S. Cl. 382/284; 382/294

(57) ABSTRACT

A system is described for generating a rectified mosaic image from a plurality of individual images, the system comprising a quadrangular region defining module, a warping module and a mosaicing module. The quadrangular region defining module is configured to define in one individual image a quadrangular region in relation to two points on a vertical anchor in the one individual image and mappings of two points on a vertical anchor in at least one other individual image into the one individual image. The warping module is configured to warp the quadrangular region to a rectangular region. The mosaicing module configured to mosaic the quadrangular region to the mosaic image. The system further generates a mosaic from a plurality of panoramic images, the system comprising a motion determining module, a normalizing module, a strip selection module, and a mosaicing module. The motion determining module is configured to determine image motion between two panoramic images. The normalizing module is configured to normalize respective columns in the panoramic images in relation to the ratio of the image motion thereof to the image motion of a selected column, thereby to generate normalized panoramic images. The strip selection module is configured to select strips of the normalized panoramic images. The mosaicing module is configured to mosaic the selected strips together.

### FIELD OF THE INVENTION

The invention relates generally to the field of generating mosaic images and more particularly to generating a rectified mosaic image from a series of images recorded by a moving camera.

### BACKGROUND OF THE INVENTION

In mosaicing of images, a number of overlapping images of a scene are initially recorded by a camera. Using information in the regions in which the images overlap, a single image is generated which has, for example, a wider field of view of the scene than might be possible otherwise. Typically, mosaic images are generated in connection with a plurality of individual images that are recorded by a camera that is rotated around a stationary optical axis. Such mosaic images provide a panoramic view around the optical axis. Additionally, mosaic images are generated from images recorded by, for example, an aerial camera, translating parallel to the scene and the optical axis is perpendicular both to the scene and to the direction of camera motion.

Problems arise, however, in connection with mosaic images that are be made from images recorded by a camera whose optical axis is moved, that is, translated along a particular path and/or rotated around an axis, particularly when different parts of a scene are located at different distances from the camera When different parts of a scene are located at different distances from the camera, from image to image they appear to move at different rates. That is, when the camera is moved from the location at which one image is recorded, to the location at which the next image is recorded, with objects in the scene that are close to the camera will move in the image more than objects that are farther from the camera Similarly, when the camera is rotated from one angular orientation at which one image is recorded, to another angular orientation at which another image is recorded, objects in the scene whose viewing direction makes a larger angle to the rotation axis will move in the image more than objects whose viewing direction makes a smaller angle with the rotation axis. In both cases, when the images are mosaiced, when corresponding points are located in successive images and the images are aligned to form the mosaic therebetween, the images will be mosaiced at an incorrect angle with respect to each other, resulting in a curled mosaic image.

Another problem can arise if, for example, the viewing direction of the camera is not pointed in a direction generally perpendicular to the direction of motion, but instead at an angle thereto. In that case, for example, assume that the camera moves to the right and that the camera is pointed somewhat in the direction of motion, the image contents will generally expand from frame to frame, as the camera gets closer to the objects in sight. When the second image is warped so that corresponding points will match the first image, the size of the second image will shrink resulting in a mosaic that tapers from left to right. Similarly, when the camera is pointed backward from the direction of motion, the image contents generally shrink from frame to frame. When the second image is warped so that corresponding points will match the first image, the size of the second image will increase, resulting in a mosaic whose dimensions increase from left to right.

### SUMMARY OF THE INVENTION

The invention provides a new and improved system and method for generating a rectified mosaic image from a series of images recorded by a moving camera.

In brief summary, in one aspect the invention provides a system for generating a rectified mosaic image from a plurality of individual images, the system comprising a quadrangular region defining module, a warping module and a mosaicing module. The quadrangular region defining module is configured to define in one individual image a quadrangular region in relation to two points on a vertical anchor in the one individual image and mappings of two points on a vertical anchor in at least one other individual image into the one individual image. The warping module is configured to warp the quadrangular region to a rectangular region. The mosaicing module configured to mosaic the quadrangular region to the mosaic image.

In another aspect, the invention provides a system for generating a mosaic from a plurality of panoramic images, the system comprising a motion determining module, a normalizing module, a strip selection module, and a mosaicing module. The motion determining module is configured to determine image motion between two panoramic images. The normalizing module is configured to normalize respective columns in the panoramic images in relation to the ratio of the image motion thereof to the image motion of a selected column, thereby to generate normalized panoramic images. The strip selection module is configured to select strips of the normalized panoramic images. The mosaicing module is configured to mosaic the selected strips together.

### BRIEF DESCRIPTION OF THE DRAWINGS

This invention is pointed out with particularity in the appended claims. The above and further advantages of this invention may be better understood by referring to the following description taken in conjunction with the accompanying drawings, in which:

FIG. 1 schematically depicts a system for generating a rectified mosaic image from a series of images recorded by a moving camera, constructed in accordance with the invention;

FIG. 2 schematically depicts operations performed in connection with generating a mosaic image from a series of individual images;

FIGS. 3A through 3D are useful in describing a problem that can arise in connection with generating a mosaic image from a plurality of images of a scene using a moving camera;

FIGS. 4A through 4D are useful in describing a second problem that can arise in connection with generating a mosaic image from a plurality of images of a scene using a moving camera;

FIGS. 5A through 5D are useful in describing a third problem that can arise in connection with generating a mosaic image from a plurality of images of a scene using a moving camera;

FIGS. 6 and 7 are useful in connection with understanding one methodology used by the system depicted in FIG. 1 in connection with correcting the problem described in connection with FIGS. 5A through 6D;

FIG. 8 is a flowchart depicting operations performed by the system in connection with the methodology described in connection with FIGS. 6 and 7;

FIG. 9 is useful in connection with understanding a second methodology used by the system depicted in FIG. 1 in connection with correcting the problem described in connection with FIGS. 5A through 6D;

FIG. 10 is a flowchart depicting operations performed by the system in connection with the methodology described in connection with FIGS. 10;

FIGS. 11A through 11C are useful in connection with operations performed by the system in connection with generating a mosaic of panoramic images; and

FIG. 12 is a flow chart depicting operations performed by the system in connection with generating mosaic panoramic images.

### DETAILED DESCRIPTION OF AN ILLUSTRATIVE EMBODIMENT

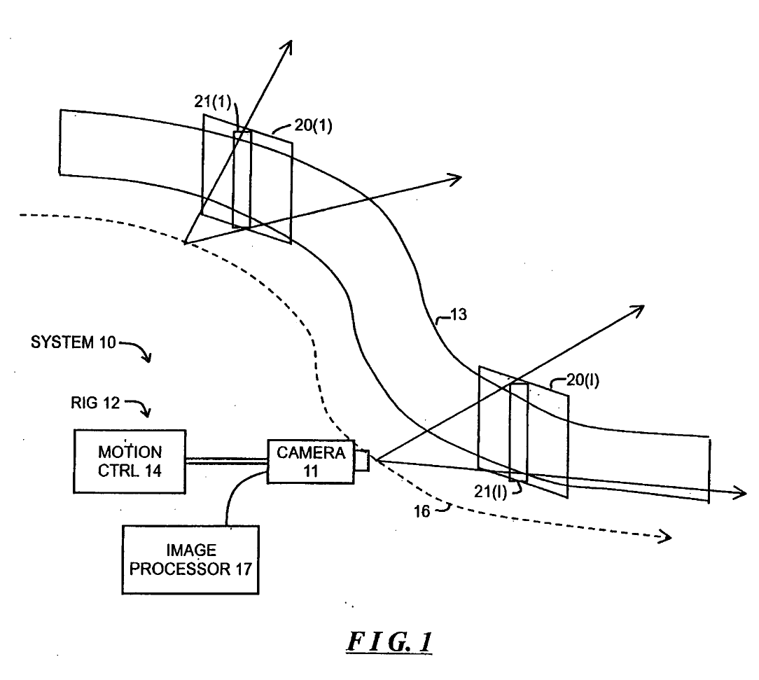

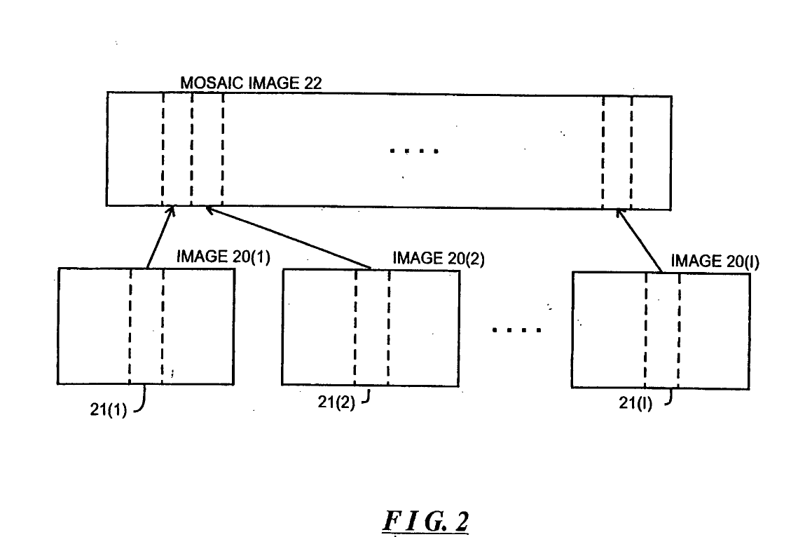

FIG. 1 schematically depicts a system 10 for generating a mosaic image from a series of images recorded by a moving camera, constructed in accordance with the invention. With reference to FIG. 1, system 10 includes a camera 11 that is mounted on a rig 12. The camera 11 may be any type of camera for recording images on any type of recording medium, including, for example, film, an electronic medium such as charge-coupled devices (CCD), or any other medium capable of recording images. The rig 12 facilitates pointing of the camera 11 at a scene 13 to facilitate recording of images thereof. The rig 12 includes a motion control 14 configured to move the camera 11. In moving the camera 11, the motion control can translate the camera 11, rotate it around its axis, or any combination thereof. In one embodiment, it will be assumed that the motion control 14 can translate the camera 11 along a path 16 and rotate the camera during translation. While the camera 11 is being moved, it can record images 20(I), . . . , 20(I) (generally identified by reference numeral 20(i)) of the scene 13 from a series of successive locations along the path 16. The individual images recorded at the successive locations are provided to an image processor 17 for processing into a unitary mosaic image, as will be generally described in connection with FIG. 2. Preferably the successive images 20(i) will overlap, which will facilitate generation of the mosaic image as described below.

As noted above, the image processor 17 processes the series of individual images to generate a unitary mosaic image. Operations performed by the image processor 17 in connection with that operation will generally be described in connection with FIG. 2. With reference to FIG. 2, the image processor 17 will initially receive two or more images 20(i). Thereafter the image processor 17 will process two individual images, for example, images 20(1) and 20(2) to find overlapping portions 21(1) and 21(2) of the scene generally toward the right and left sides of the respective images 20(1) and 20(2), respectively, and use those corresponding portions 21(1) and 21(2) to align the images 20(1) and 20(2). Given the alignment, portions 21(1) and 21(2) can be defined in images 20(1) and 20(2) such that they can be combined to form a portion of the mosaic image 22. Thereafter, similar operations can be performed in connection with the next image 20(3) in the series and the portion of the mosaic image 22 generated using images 20(1) and 20(2) to further extend the mosaic image 22. These operations can be performed in connection with the remaining images 20(4), . . . , until all of the images 20(i) have been used to generate the mosaic.

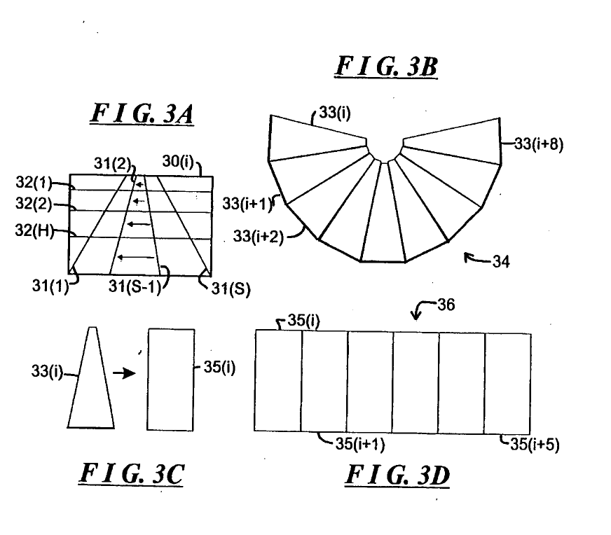

Several problems arise in connection with generation of the mosaic image 21 as described above. One such problem will be described in connection with FIGS. 3A through 3D. As noted above, when the image processor 17 processes two successive individual images 20(1) and 20(2) to mosaic them together, or an individual image 20(i) (i>2) and the previously-generated mosaic image 22, it uses overlapping portions to align the respective images 20(1) and 20(2). The problem described in connection with FIGS. 3A through 3D arises when features that are used to align the individual images do not have a uniform image motion. This problem can, for example, be described in connection with a planar surface that is tilted with respect to the camera 11, so that, for example, the planar surface is parallel to the path 16 along which the camera is translated, but tilted so that the lower portion of the planar surface is closer to the camera 11 and the upper portion of the planar surface farther away from the camera 11. To provide information for aligning the successive individual images when the mosaic image is generated, the planar surface is provided with a series of equi-distant vertical lines.

In that case, each of the individual images will appear as the image 30(i) depicted FIG. 3A, with the vertical lines appearing as slanted lines 31(1) through 31(S) (generally identified by reference numeral 31(s)). Since the lower part of the image 30(i) is of the portion of the planar surface that is closer to the camera 11, and the upper part of the image 30(i) is of the portion of the planar surface that is farther from the camera 11, the vertical lines on the planar surface will be recorded as the slanted lines 31(s). The perspective due to the tilting of the planar surface causes the lines that are to the left of the center of the image 30(i) to be slanted toward the right and the lines that are to the right of the center to be slanted toward the left in the image 30(i). The distance between locations along the path 16 at which images 30(i), 30(i+1), . . . are recorded will be such as to allow the portions of the scene recorded in the images to overlap so that, for example, slanted line 31(S-1) in image 30(i+1) corresponds to slanted line 31(2) in image 30(i); otherwise stated, the image motion, or motion of objects in the successive images from image 30(i) to image 30(i+1), is such that line 31(S-1) in image 30(i) corresponds to line 31(2) in image 30(i−1).

Conventionally, as described above, when a mosaic image 34 is generated using images 30(i) as described above, strips 32(i) from the successive images 30(i) will be used as shown in FIG. 3B. Since line 31(S-1) in image 30(i) corresponds to line 31(2) in the successive image 30(i+1), conventionally in each image 30(i) the strip 33(i) obtained from the image 30(i) for use in the mosaic can be defined by lines 31(2) and 31(S-1) in the image 30(i). Accordingly, when the strips 33(i), 33(i+1) obtained form the two images 30(i) and 30(i+1) would be aligned to form a mosaic as shown in FIG. 3B, with the resulting mosaic being curled. The strength of the curl is, in the case of a rotating camera, a function of the angle between the viewing direction and the rotation axis, and, in the case of a translating camera, a function of the angle with which the planar surface is tilted with respect to the image plane of the camera 11.

As will be described below in greater detail, the problem described above in connection with FIGS. 3A and 3B can be corrected by rectifying the strips 33(i) as shown in FIG. 3C to provide successive rectangular strips 35(i), which, as shown in FIG. 3D, can be mosaiced together to provide a rectified mosaic image 36. Generally, the orientation of the planar surface relative to the image plane of the camera 11 is unknown, but the amount of distortion, if any, that is caused by the orientation can be determined from the optical flow, that is, the change of the position and orientation of respective vertical lines as between successive images. After the amount of distortion has been determined, the image processor 17 can process each of the individual images to correct for the distortion prior to integrating them into the mosaic.

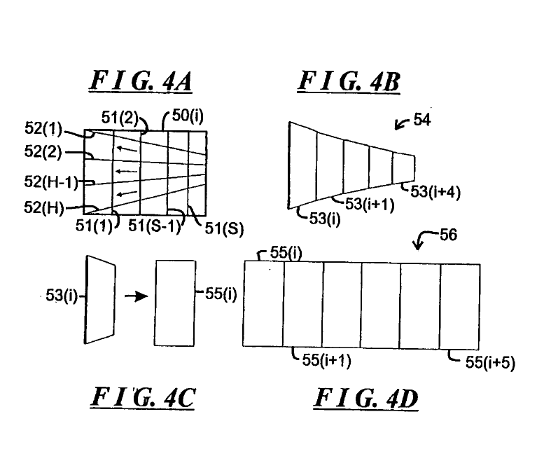

Another problem will be described in connection with FIGS. 4A through 4D. In the situation to be described in connection with FIG. 4, the camera 11 is moving from left to right parallel to a vertical planar surface, and is tilted forward, that is, tilted to the right with respect to the planar surface. In that case, the planar surface is provided with lines running horizontally as well as vertically, and the camera is tilted with respect to the planar surface in such a manner that it points to the right. Accordingly, and with reference to FIG. 4A, an image 50(i) recorded by the camera, the vertical lines 51(1), 51(2), . . . will remain vertical, but the horizontal lines 52(1), 52(2), . . . that are above the horizontal center of the image 50(i) will be angled in a downward direction from left to right, while horizontal lines 52(H), 52(H-1), . . . that are below the horizontal center of the image 50(i) will be angled in an upward direction from left to right. As is the case in connection with image 30(i) (FIG. 3A), line 51(S-1) in image 50(i) corresponds to line 51(2) in image 50(i+1). Thus, mosaicing a strip 53(i) from an image 50(i), the strip can be defined by vertical lines 51(2) and 51(S-1) on the left and right sides, and, for example, by lines 52(1) and 52(H) at the top and the bottom, in each image 50(i), 50(i+1), . . . . It will be appreciated that, in matching a strip 53(i+1) from image 50(i+1) to the left edge of a strip 53(i) from the preceding image 50(i), the strip 53(i+1) will be warped so that the respective horizontal lines 52(1), 52(2), . . . , 52(H-1), 52(H) along the left edge of the strip 53(i) will match the same lines 52(1), 52(2), . . . , 52(H-1), 52(H) along the right edge of the strip 53(i+1). Accordingly, the mosaic image 54 formed from successive strips will taper from left to right. As shown in FIG. 4C, the image processor 17 can rectify this distortion by rectifying each strip 53(i), 53(i+1), . . . , to form rectangular strips 55(i), 55(i+1), with the rectification being such as to make the lines 52(1), 52(2), . . . , 52(H-1), 52(H) return to a horizontal orientation and mosaic the rectangular strips together to form the mosaic image 56 (FIG. 4D).

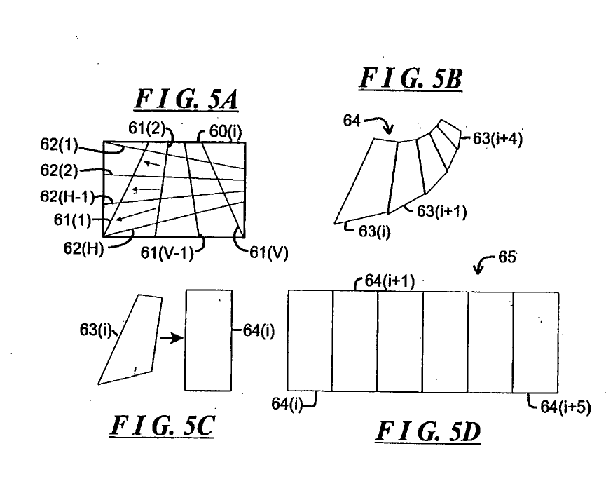

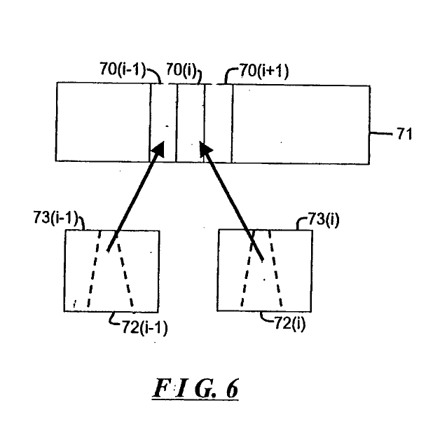

A third problem, which generally is a combination of those described above in connection with FIGS. 3A through 3D and 4A through 4D, will be described in connection with FIGS. 5A through 5D. In the problem to be described in connection with FIGS. 5A through 5D, both the planar surface comprising the scene and the camera 11 recording images of the scene may be tilted. As with the planar surface described above in connection with FIGS. 4A through 4D, the planar surface in this case includes a plurality of vertical and horizontal lines. In that case, each image 60(i) as recorded by the camera will as shown in FIG. 5A, with the region subsumed by the vertical lines 61(1), . . . , 61(V) (generally identified by reference numeral 61(v)) tapering vertically from bottom to top (as is the case in the example described above with reference to FIGS. 3A through 3D), and the region subsumed by the horizontal lines 62(1), . . . , 62(H) (generally identified by reference numeral 62(h)) tapering horizontally from left to right. If the motion of camera 11 as between successive images 60(i), 60(i+1), . . . is such that the vertical line 61(V-1) in image 60(i) corresponds to the same line in the scene 12 as line 61(2) in image 60(i+1) when the image processor 17 mosaics strips from the successive images 60(i), 60(i+1), . . . it can select as the strip the region of each image bordered by vertical lines 61(1) and 61(2) and horizontal lines 62(1) and 62(H). In that case, if the strip 63(i) for the mosaic image 64 (reference FIG. 5B) is obtained from image 60(i), since the strip 63(i+1) from image 60(i+1) will be warped so that the length of its left edge corresponds to the length of the right edge of strip 63(i), that strip 63(i+1) will be proportionately smaller and disposed at a different angle than the strip 63(i) in the mosaic image 64. Each subsequent strip 63(i+2), . . . , will also be proportionately smaller than, and disposed at a corresponding angle to, the previous strip 63(i+1), . . . , and so the resulting mosaic image 64 will both be curved and taper from left to right. The image processor 17 can rectify this distortion by rectifying each strip 63(i) both horizontally and vertically to form a rectangular strip 64(i) (reference FIG. 5C) prior to mosaicing it to the mosaic image 65 (reference FIG. 5D).

Details of how the image processor 17 generally rectifies distortion using information from apparent motion in successive images will be described in connection with FIGS. 6 through 8. Generally, as will be appreciated from the above, each strip . . . , 70(i−1), 70(i), 70(i+1), . . . in the mosaic image 71 is obtained from a respective strip . . . , 72(i−1), 72(i), 72(i+1), . . . in successive images . . . , 73(i−1), 73(i), 73(i+1), . . . recorded by the camera 11. To fully define the transformation to be used for the rectification, the image processor 17 will need to define the borders of each strip 70(i) in the mosaic image 71, the borders of the regions in the respective images 73(i) that will comprise for the respective strips 72(i) and the mapping transformation from the strip 72(i) to the strip 70(i). To accomplish that, the image motion between successive pairs of images 73(i−1), 73(i) and 73(i), 73(i+1) is determined. Generally, for image 73(i), the image processor 17 defines the region that is to comprise the strip 72(i) to satisfy three conditions, namely:

(i) One border 74(i)(1) of the region should match the border 74(i−1) of the region of image 73(i−1) that is to comprise strip 72(i−1) in the preceding image 73(i−1), which will map to the border 75(i−1) between strips 70(i−1) and 70(i) in the mosaic image 71;

(ii) The border 74(i)(2) of the region that is to comprise the strip 72(i), which will map to the border 75(i) between strips 70(i) and 70(i+1) in the mosaic image 71, is chosen such that the distance between the two borders 74(i)(1) and 74(i)(2) is proportional to the image motion at each border location; this will ensure that the mosaic image 71 is constructed linearly and not curved; and

(iii) The top and bottom borders 76(i) and 77(i) of the region of image 73(i) that is to comprise strip 72(i) should pass through the top and bottom ends of some vertical column in the image 73(i), such as the vertical column at the center of the image 73(i); this will ensure that the strip 70(i) is not expanded or shrunk in the mosaic image 71.

The rectangular strips . . . , 70(i−1), 70(i), 70(i+1), . . . in the mosaic 71 have a uniform height to provide a mosaiced image 71 of uniform height and to avoid expanding or shrinking the mosaic image 71 vertically. However, the vertical location of the strip 70(i) in the mosaic image 71 changes according to the vertical motion or tilt of the camera 11. The width of the strip 70(i) is determined by the motion of the scene 12 from image to image.

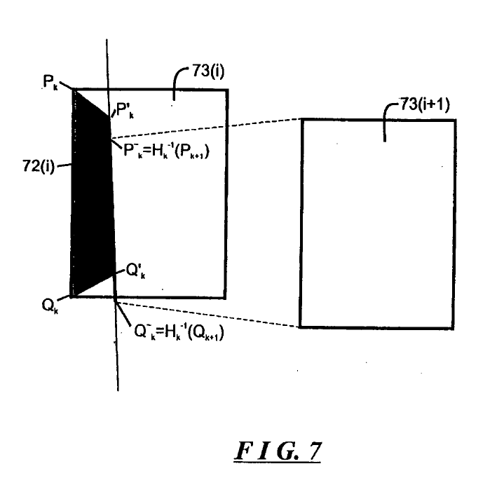

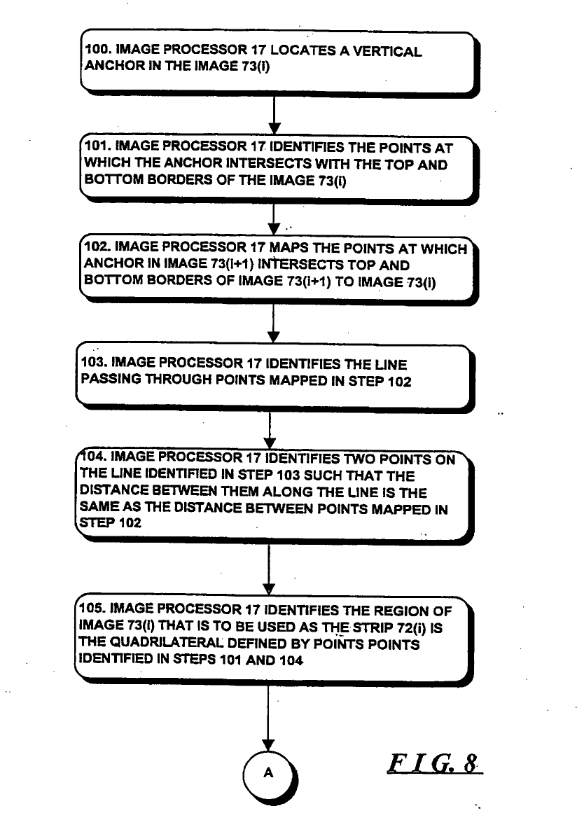

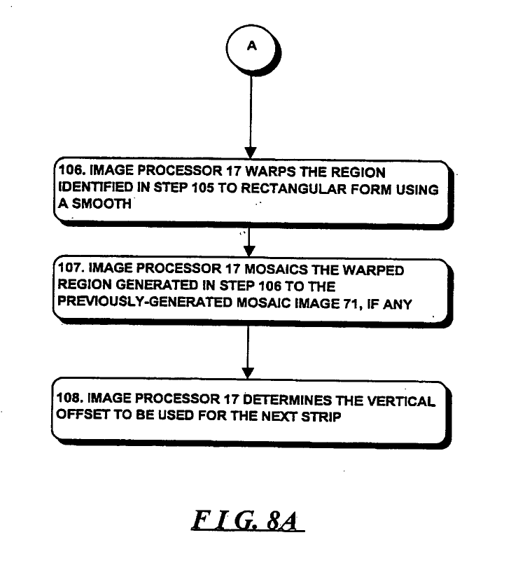

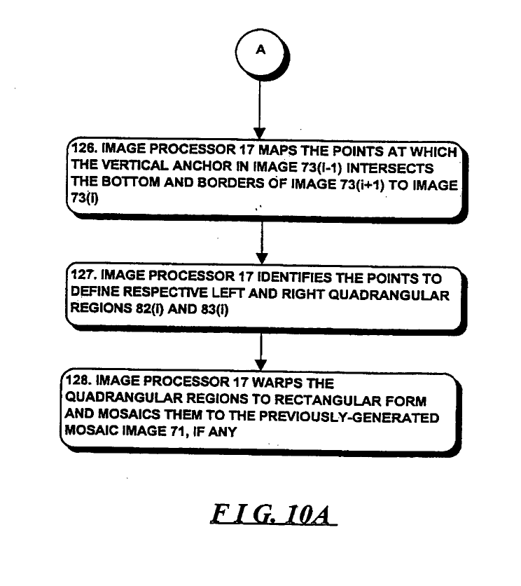

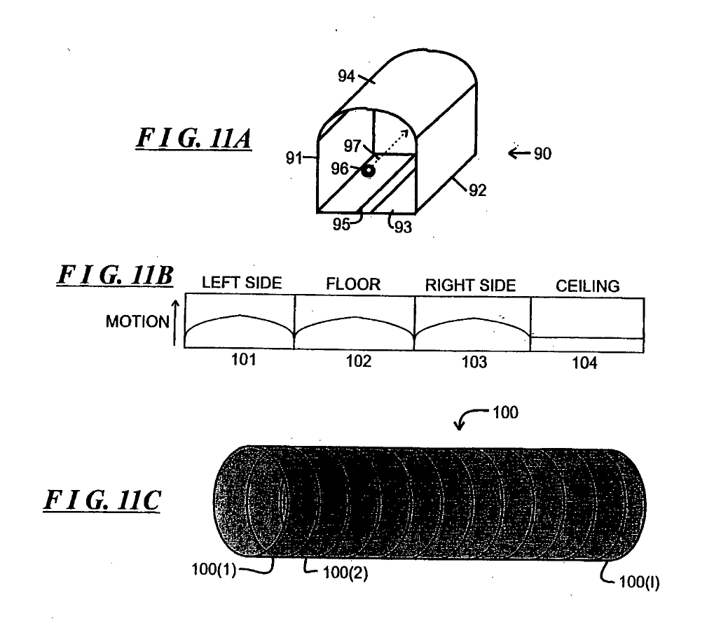

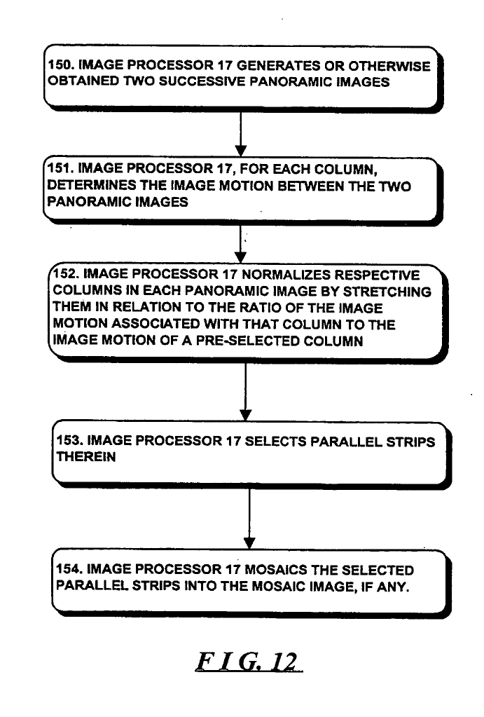

In the case images recorded of a scene comprising a planar surface, or images recorded by a tilted rotating camera, operations performed by the image processor 17 in one embodiment in generating the strip 70(i) to be used in generating the mosaic image 71 will be described in connection with FIG. 7 and the flowchart in FIG. 8. Generally, in the embodiment described in connection with FIGS. 7 and 8, the image processor 17 obtains the strip as defined one side of an vertical anchor. The vertical anchor is a vertical feature in the image that remains invariant under the transformation that warps a strip in the image to a strip in the mosaic. Only transformations that keep the anchor invariant will be considered for warping a strip in the image to a strip in the mosaic. The vertical anchor may be anywhere in the image 73(i), illustratively, the center, the left border, or other column; in the embodiment described in connection with FIGS. 7 and 8, the vertical anchor is selected to be the left border of the image 73(i), and that vertical anchor will also form the left border of the strip 70(i). Another embodiment, in which the strip is defined on two sides of a vertical anchor, will be described below in connection with FIGS. 10 and 11.

With reference to FIGS. 7 and 8, the image processor 17 will initially locate the vertical anchor in the image 73(i) (step 100) and identify the points Pₖ and Qₖ (where index “k” has the same value as index “i”) at which the anchor intersects with the top and bottom borders of the image 73(i) (step 101). Using the homography Hₖ⁻¹ between images 73(i+1) and 73(i), the image processor also maps the points Pₖ₊₁ and Qₖ₊₁ in image 73(i+1) to image 73(i) as points P⁻ₖ and Q⁻ₖ, respectively (step 102). It will be appreciated that points Pₖ₊₁ and Qₖ₊₁ comprise, respectively, the points at which the anchor in image 73(i+1), that is, the left border of the image 73(i), intersects the top and bottom of that image 73(i+1), and so P⁻ₖ=Hₖ⁻¹(Pₖ₊₁) and Qₖ₊₁).

After the image processor 17 has located points P⁻ₖ and Q⁻ₖ, it identifies the line Lₖ passing therethrough (step 103) and then identifies two points P′ₖ and Q′ₖ on the line such that the distance between them along the line Lₖ is the same as the distance between points P⁻ₖ and Q⁻ₖ, and their centroid is in the middle row of the image (step 104). The image processor can determine the region of image 73(i) that is to be used as the strip 72(i) is the quadrilateral defined by points P′ₖ, Q′ₖ, Qₖ and Pₖ (step 105) and warp the strip to rectangular form using a smooth (for example, bilinear) interpolation of the coordinates of those points, thereby to generate the strip 70(i) (step 106). It will be appreciated that the use of an interpolation is an approximation of the real transformation, which is unknown, but if the strip 72(i) is relatively narrow, the approximation will suffice. Thereafter, the image processor 17 can mosaic the strip 70(i) to the previously-generated mosaic image 71, if any (step 107).

In addition, the image processor 17 will determine the vertical offset to be used for the next strip 70(i+1) (step 108). In that operation, the image processor will determine the vertical offset as

$$‖ {Q}_{k}^{∼} - {Q}_{k}^{′} ‖ ⋆ \frac{h}{‖ {Q}_{k}^{′} - {P}_{k}^{′} ‖} ,$$

where ∥A−B∥ refers to the distance between two points A and B and “h” is the image height.

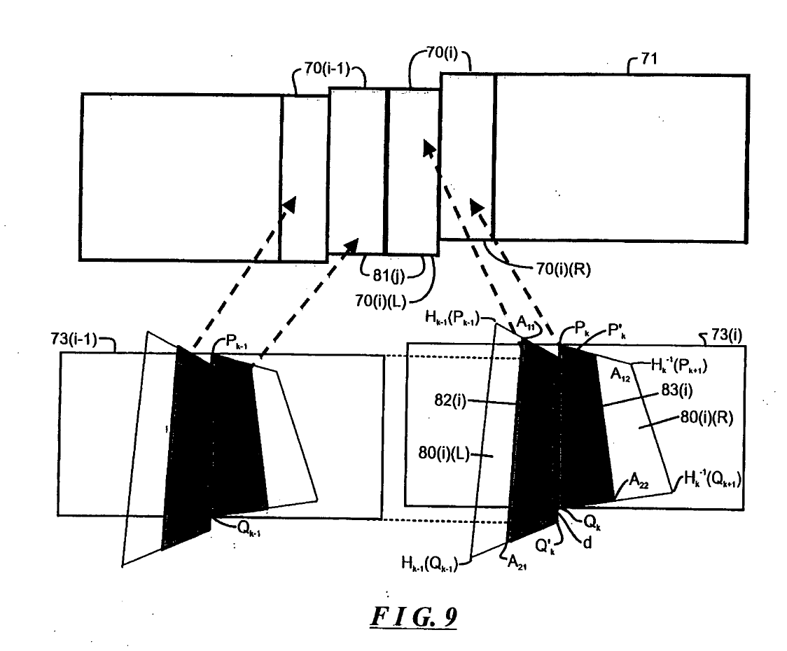

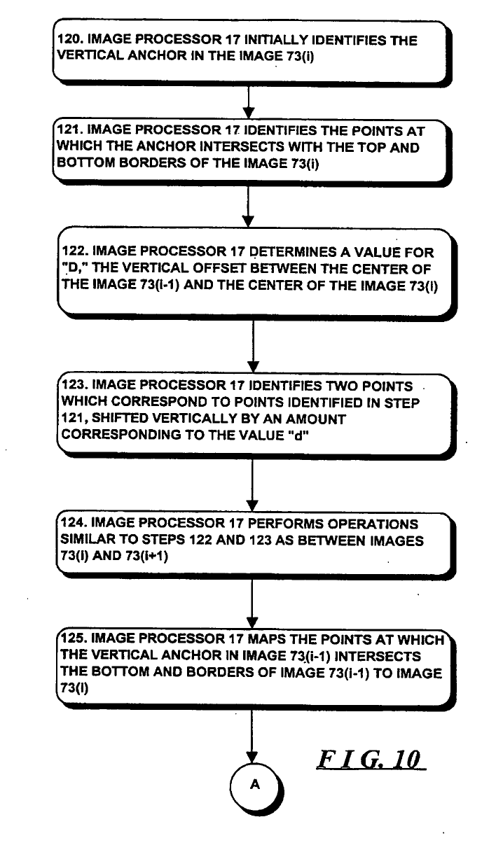

As noted above, a second embodiment, in which the strip is defined on two sides of a vertical anchor, is described in connection with FIGS. 9 and 10. The vertical anchor may be any column in the image 73(i); in one embodiment is selected to be the center column, since that will reduce lens distortion. In this embodiment, the image processor identifies two regions, approximately symmetric on opposing sides of the center column, both of which be warped to form respective portions of the strip 70(i) to be used in the mosaic image 71. With reference to FIGS. 9 and 10, the image processor 17 will initially identify the vertical anchor in the image 73(i) (step 120) and identify the points Pₖ and Qₖ at which the anchor intersects with the top and bottom borders of the image 73(i) (step 121). Thereafter, the image processor 17 will determine a value for “d,” the vertical offset between the point Oₖ₋₁ that comprises the center of the image 73(i−1), that is, the projection of point Oₖ₋₁ in image 73, that is, Hₖ₋₁(Oₖ₋₁) (step 122), where Hₖ₋₁ is the homography between image 73(i−1) and image 73(i), and identify two points P′ₖ and Q′ₖ which correspond to points Pₖ and Qₖ shifted vertically by an amount corresponding to the value “d” (step 123). The image processor 17 will perform operations similar to steps 122 and 123 as between images 73(i) and 73(i+1) using the homography Hₖ therebetween (step 124).

In addition, the image processor 17, using the homography Hₖ₋₁, maps the points Pₖ₋₁ and Qₖ₋₁ to image 73(i) as points Hₖ₋₁(Pₖ₋₁) and Hₖ₋₁(Qₖ₋₁), respectively (step 125), and, using the homography Hₖ₋₁, maps points P′ₖ₊₁ and Q′ₖ₊₁ to image 73(i) as points H⁻¹ₖ(P′ₖ₊₁) and H⁻¹ₖ(Qₖ₊₁) (step 126). The points Hₖ₋₁, (Pₖ₋₁), P′ₖ, Q′ₖ, and Hₖ₋₁(Qₖ₋₁) define a left quadrangular region 80(i)(L), and points Pₖ, H⁻¹ₖ(Pₖ₊₁), H⁻¹ₖ(Qₖ₋₁) and Qₖ define a right quadrangular region 80(i)(R), a portion of each of which will be used in generating respective rectangular portions 81(i)(L) and 81(i)(R) that together will be used as the strip for the image 73(i) in the mosaic image 71. Essentially, it will be desired to use left quadrangular region 80(i)(L), along with the right quadrangular region 80(i−1)(R) associated with the previous image 74(i−1), in connection with a rectangular region 81(j) in the mosaic image 71. Similarly, it will be desired to use the right quadrangular region 80(i)(R), along with the left quadrangular region 80(i+1)(L) associated with the next image 73(i+1), in connection with the next rectangular region 81(j+1) in the mosaic image 71. The size and shape of the respective rectangular regions is somewhat arbitrary. Since both images 73(i−1) and 73(i) are used to provide half of the image to be used in the rectangular region 81(j), it will be appreciated that the points Hₖ₋₁(Pₖ₋₁) P′ₖ, Q′ₖ, and Hₖ₋₁(Qₖ₋₁) that define the left quadrangular region 80(i)(L) will also relate to the points defining the corners of the rectangular region 81(j), and it will be necessary to find the points A₁₁ and A₂₁ that relate to the mid-points of the top and bottom of the rectangular region 81(j), respectively. Accordingly, the portion of quadrangular region 80(i)(L) that will be used in connection with the left-hand portion of strip 70(i) is the quadrangular region 82(i) defined by points A₁₁, P′ₖ, Q′ₖ, and A₂₁. Similarly, points Pₖ, H⁻¹ₖ(Pₖ₊₁), H⁻¹ₖ(Qₖ₋₁) and Qₖ that define the right quadrangular region 80(i)(R) will also relate to the points defining the corners of the rectangular region 81(j+1), and it will be necessary to find the points A₁₂ and A₂₂ that relate to the mid-points of the top and bottom of the rectangular region 81(j+1), respectively. Accordingly, the portion of quadrangular region 80(i)(R) that will be used in connection with the left-hand portion of strip 70(i) is the quadrangular region 83(i) defined by points Pₖ, A₁₂, A₂₂ and Qₖ. The rectangular regions 81(j) and 81(j1) can both be defined by points UVWX, with points U and V defining the left and right top corners, respectively, and points W and X defining the right and left bottom corners, respectively. In that case the relationship between the left and right quadrangular regions 80(i)(L) and 80(i)(R) will be defined by respective homographies F_{L} and F_{R}.

Accordingly, following step 126, the image processor 17 will identify the points A₁₁, A₂₁, A₁₂ and A₂₂ as

$${A}_{11} = {F}_{L} ( \frac{U + V}{2} ) , {A}_{21} = {F}_{L} ( \frac{W + X}{2} ) \\ {A}_{12} = {F}_{R} ( \frac{U + V}{2} ) , {A}_{22} = {F}_{R} ( \frac{W + X}{2} ) \qquad ( 1 )$$

(step 127), and warp the portion of the quadrangular region defined by points A₁₁, P′ₖ, Q′ₖ and A₂₁ to the right portion of the rectangular region 81(j) and the portion of the quadrangular region defined by points A₁₂, Pₖ, Qₖ and A₂₂ to the left portion of the rectangular region 81(j+1) by a smooth (for example, bilinear) interpolation thereby to provide respective rectangular portions 70(i)(L) and 70(i)(R) of the strip 70(i) associated with image 73(i), with the rectangular portion 81(i)(R) being vertically offset from rectangular portion 81(i)(L) by the value “d” determined in step 122 (step 128).

In the system 10 as described above in connection with FIGS. 1 through 10, the camera 11 has been one that records images in a particular direction. As a further aspect of the invention, the image processor 17 can also generate a mosaic of a plurality of panoramic images. Typically, a panoramic image is generated from a plurality of images recorded from a number of angular orientations around a common axis, which images are mosaiced together to provide a single panoramic image of the scene surrounding the axis. The panoramic image so generated is typically the full 360 degree circle surrounding the axis, or a substantial part thereof The images that are used in generating the panoramic image may be recorded by a single camera that is rotated around the axis to facilitate recording of the images from the requisite plurality of angular orientations, or by a plurality of cameras disposed at the requisite angular orientations. A panoramic image can also be obtained by a single camera with a very wide field of view, which may be provided by a very wide angle lens, a combination of lenses and mirrors, or other arrangements as will be apparent to those skilled in the art. The panoramic image may be cylindrical or alternatively it may be flat. In accordance with this aspect of the invention, the images are recorded to facilitate generation of a plurality of panoramic images recorded at successive locations along the axis, with the panoramic images overlapping such that the image processor 17 can mosaic them together along the direction of the axis.

This aspect will be described in greater detail in connection with FIGS. 11A through 12. With reference to FIG. 11A, that FIG. schematically depicts a train tunnel 90 having left and right sides 91 and 92, a floor 93 and a ceiling 94. The left and right sides 91 and 92 and the floor are planar surfaces, and the ceiling 94 is arched. A pair of tracks 95 is disposed on the floor to facilitate traversal of the tunnel by a train (not shown). A panoramic camera 96, comprising, for example, a plurality of individual cameras disposed around a common axis 97, which extends generally parallel to the length of the tunnel, records images along the axis from a plurality of angular orientations. The camera 96 is moved along the axis 97 to facilitate recording of images from which a series of panoramic images along the axis 97 can be generated, which series can be processed as described below in connection with FIG. 13, and the processed panoramic images 100(1), 100(2), . . . mosaiced together to form a single mosaic panoramic image 100 (FIG. 11C).

As noted above, the tunnel 90 comprises left and right sides 91 and 92, a floor 93 and a ceiling 94. In the following, it will be assumed that the surface of the ceiling 94 is cylindrical with an axis corresponding to the axis 97. In addition, it will be assumed that the distance from axis 97 to each of the left and right sides 91 and 92 and floor 93 is smallest at the center of the left and right sides and floor, and largest at the corners. In that case, the image motion, that is, the apparent motion of features and objects in the images as between panoramic images will be as depicted in the graph depicted FIG. 11B. With reference to FIG. 11B, since, for each of the left and right sides 91 and 92 and floor 93, the distance from the axis 97 thereto increases from the center to the two corners, the image motion decreases from the center to the two corners, as shown in left, bottom and right graph segments 101, 102 and 103 in FIG. 11B. On the other hand, since, for the ceiling 94, the distance from the axis is constant, the image motion will also be constant, as shown in the top graph segment 104 in FIG. 11B. If the internal parameters of the camera 96 are known it will be appreciated that the shape of the tunnel 90, to a scale factor, can readily be determined using the image motion. In addition, given certain other information, such as the distance from the axis 97 to the tracks 95, the scale factor can also be determined.

The image processor 17, in generating a mosaic panoramic image 101 from the individual panoramic images 100(1), 100(2), . . . , will process the individual panoramic images to correct for the differences in the image motion. Operations performed by the image processor 17 in generating a mosaic panorama image 100 will be described in connection with the flow chart in FIG. 11. With reference to FIG. 12, after the image processor 17 has generated or otherwise obtained two successive panoramic images 100(i), 100(i+1) that are to be mosaiced together (step 150), for each column it determines the image motion between the two panoramic images (step 151). The image motion as determined by the image processor 17 may have a motion profile similar to that described above in connection with FIG. 13, with image motion of regions relatively close to the camera being relatively high and image motion of regions further away being relatively low.

Thereafter, the image processor 17 normalizes respective columns in each panoramic image 100(i), 100(i+1) by stretching them in relation to the ratio of the image motion associated with that column to the image motion of a pre-selected column (step 152), each column comprising the series of picture elements in the direction parallel to the axis 97. The pre-selected column may be the column with the highest motion, or any other selected column in the panoramic image. Preferably, in performing step 152, the image processor 17 will leave at least one row or set of columns unchanged. If for example, the image processor 17 does not normalize the columns of the portion of the panoramic image relating to the floor 91, in the resulting mosaic panoramic image the floor will appear to be flat and the ceiling 94 will appear to be curved. On the other hand, if the image processor 17 does not normalize the columns of the portion of the panoramic image relating to the ceiling 94, in the resulting mosaic panoramic image the ceiling will appear to be flat and the floor will appear to be curved. Similarly, if the image processor does not normalize the columns of the portion of the panoramic image relating to the left and/or right sides, in the mosaic panoramic image the left and/or right sides will appear to be flat and both the ceiling and floor will appear to be curved.

After the image processor 17 has normalized the respective panoramic images 100(i), 100(i+1) (step 152), it will select parallel strips therein (step 153) and mosaic the parallel strips into the mosaic image 100 (step 154).

The system 10 provides a number of advantages. In one aspect, the system provides an arrangement that can generate mosaic images of scenes including tilted surfaces using a translated camera that is pointed toward the scene generally sideways. In this aspect, the camera may be translated in a direction that is parallel to the tilted surface and pointed directly thereat, that is, perpendicular to the translation direction (reference FIGS. 3A through 3D). Alternatively, and more generally, the camera may be pointed in a direction that is tilted with respect to the direction of motion (reference FIGS. 7A through 10).

In another aspect, the system 10 can generate a mosaic of panoramic images (reference FIGS. 11A through 12) and in connection therewith can determine the shapes of surfaces in the mosaic images. In connection with this aspect, although the system 10 was described as generating a mosaic of panoramic images of a train tunnel, it will be appreciated that the system can generate such a mosaic panoramic image of a variety of kinds of scenes, including but not limited to water or sewer pipes, corridors and hallways, and the like.

It will be appreciated that a number of modifications may be made to the system 10 as described above. For example, it will be appreciated that, if the camera 11 is translated, it may be translated in any direction with respect to the scene 13. In addition, although the system 10 has been described as performing operations in connection with a scene 13 that has vertical and/or horizontal lines, it will be appreciated that the operations can be performed in connection with any pattern or set of points that appear along such lines.

It will be appreciated that a system in accordance with the invention can be constructed in whole or in part from special purpose hardware or a general purpose computer system, or any combination thereof any portion of which may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

What is claimed as new and desired to be secured by Letters Patent of the United States is:

1-27. (canceled)

28. A method of producing a mosaic of a scene from a sequence of camera images of the scene acquired at a respective sequence of positions, the method comprising:
determining first and second anchor points in each image;
warping at least one portion of a given image of the camera images that includes the image's anchor points using a transform that changes the scale of a region in the portion and leaves the position of the two anchor points invariant; and
for each portion of the at least one portion, placing the portion adjacent a portion of an other image acquired at a position adjacent that at which the given image is acquired so that features in the portions of the given and other images are aligned.

29. A method according to claim 28 wherein warping at least one portion of the given image comprises determining for the given image and the other image, two additional points for each of the at least one portion of the given image and corresponding homologous points for the other image and warping the at least one portion responsive to the additional points.

30. A method according to claim 29 wherein the homologous and additional points correspond under a homography that transforms a portion of the given image to the other image.

31. A method according to claim 29 wherein at least a portion of a line segment between the additional points is located in the region that undergoes the scale change.

32. A method according to claim 31 wherein the at least one portion comprises one portion.

33. A method according to claim 32 and comprising determining the anchor points so that in each image a line segment between the anchor points has a same length.

34. A method according to claim 33 and comprising determining the anchor points so that in each image the line segment between the anchor points has substantially a same direction.

35. A method according to claim 34 wherein the corresponding homologous points in the other image are the anchor points of the other image.

36. A method according to claim 35 wherein warping the one portion comprises warping a quadrilateral defined by the anchor and additional points into a rectangle.

37. A method according to claim 31 wherein the at least one portion comprises two portions.

38. A method according to claim 37 and comprising determining the anchor points so that in each image a line segment between the anchor points has a same length.

39. A method according to claim 38 and comprising determining the anchor points so that in each image the line segment between the anchor points has a same direction.

40. A method according to claim 39 wherein warping a first portion of the two portions comprises warping a quadrilateral defined by the anchor points and the additional points into a rectangle.

41. A method according to claim 40 wherein warping the second portion comprises warping a quadrilateral defined by points collinear with the given image's anchor points and the additional points determined for the second portion into a rectangle.

42. A method according to claim 28 and comprising warping at least one portion of each image.

43. A method according to claim 28 and comprising placing portions of each pair of images acquired at adjacent positions adjacent each other so that features in the images are aligned and the line segments between the anchor points of the images are invariant to within a translation.

44. A method according to claim 28 wherein the line segment between the anchor points of an image is substantially perpendicular to a direction of optic flow in the image.

45. A method of producing a mosaic of a scene from a sequence of camera images of the scene acquired at a respective sequence of positions, the method comprising:
determining first and second anchor points in each image;
determining for a given image of the sequence of images and at least one other image of the sequence of images acquired at a position adjacent that at which the given image is acquired, two additional points in the first image and corresponding homologous points in the other image;
warping at least a portion of the given image using a transform that leaves the anchor points in the given image invariant so that a distance between the additional points and the corresponding points are the same; and
placing at least portions of the given and other image adjacent each other so that the additional and corresponding points are aligned.

46. A method according to claim 45 wherein the homologous and additional points correspond under a homography that transforms a portion of the given image to the other image.

47. A method according to claim 45 and comprising determining the anchor points so that in each image a line segment between the anchor points has a same length.

48. A method according to claim 47 and comprising determining the anchor points so that in each image the line segment between the anchor points has a same direction;

49. A method according to claim 45 and comprising placing portions of each pair of images acquired at adjacent positions adjacent each other so that features in the images are aligned and the line segments between the anchor points of the images are invariant to within a translation.

50. A method of producing a mosaic of a scene from a sequence of camera images of the scene acquired at a respective sequence of positions, the method comprising:
determining first and second anchor points in each image so that in each image the line segment between the anchor points has a same length and same direction;
determining for each image at least one quadrilateral region defined by two auxiliary points collinear with the image anchor points and separated by a distance equal to that which separates the anchor points, and two additional points for which at least a portion of a line between them lies in the image;
warping the at least one quadrilateral into a rectangle using a transform under which the positions of the two auxiliary points are invariant; and
aligning rectangles from images acquired at adjacent positions adjacent to each other.

51. A method according to claim 50 wherein for at least one of the quadrilateral regions the two auxiliary points that are collinear with the anchor points are coincident with the anchor points.

52. A method according to claim 51 wherein the two additional points that define a quadrilateral in a given image are homologous with corresponding points in another image acquired at a position adjacent to that at which the given image is acquired.

53. A method according to claim 52 wherein homologous points correspond to the additional points under a homography that transforms a portion of the given image to the other image.

54. A method according to claim 50 and comprising warping at least one portion of each image.

55. A method according to claim 50 and comprising placing portions of each pair of images acquired at adjacent positions adjacent each other so that features in the images are aligned and the line segments between the anchor points of the images are invariant to within a translation.
